(19) United States
(12) Patent Application Publication
(10) Pub. No.: US 2013/0085682 A1
(43) Pub. Date: Apr. 4, 2013

(54) MEMORY CARD USAGE WITH BLOOD GLUCOSE DEVICES

(71) Applicant: Steven A. Bousamra, Carmel, IN (US)

(72) Inventor: Steven A. Bousamra, Carmel, IN (US)

(73) Assignee: Roche Diagnostics Operations, Inc., Indianapolis, IN (US)

(21) Appl. No.: 13/252,488

(22) Filed: Oct. 4, 2011

(51) Int. Cl. G06F 19/10

(52) U.S. Cl. 702/21

(57) ABSTRACT

A technique and system utilizing a portable memory card in which data for an individual is stored and identified based on a personal identification number or key. With this system, a glucose meter and a health care provider are able to track testing data across multiple meters as well as between various individuals. Moreover, the system is configured to retrospectively collect structured testing data in which, while a structured test may have been intended but the specific questions or data input were not available at the time, the individual is allowed to update the data after the structured testing window. By having the data stored on a portable memory card, the individual is able to keep the data in their possession and also helps with patient confidentiality.

### BACKGROUND

Home monitoring of various health conditions, such as diabetes, has become very popular in recent years because it gives a patient greater control and understanding of their treatment regimen. However, along with this increase in the popularity of home diagnostic testing, there are a number of issues that have slowed the adoption of home diagnostic testing both in developing and industrialized countries. For example, in developing countries, there are too few meters available for diabetic patients to use for monitoring. As a result, multiple patients at a health clinic may share the same meter. This sharing of meters makes tracking individual patient data quite difficult. In contrast, in developed or industrialized countries, the relative cost of a meter is inexpensive, and a diabetic patient will commonly have more than one meter which can make data collection across the multiple meters quite difficult. This inability in either case to accurately track patient data makes diagnosing sources of glucose control problems quite difficult.

Thus, there is a need for improvement in this field.

### SUMMARY

To help better control diabetes, various testing regimens or structured tests have been developed in order to determine factors that affect an individual's blood glucose level. An example of one such structured test is an ACCU-CHEK® 360 View tool. While these structured tests as well as other tests have proven to be effective, a number of issues have been found that make compliance problematic. As one example, notably in developing countries in which multiple users utilize the same meter, data segregation is an issue. As noted before, diabetics in developing countries typically share one or more glucose meters, which in turn makes separating out the readings for the numerous users difficult, especially where some of the patients are participating in a structured testing regimen. On the other hand, in developed countries it is common that the meter cost is relatively inexpensive such that an individual may own multiple meters. While this can make it easier for the patient to monitor blood glucose levels because they may have a meter at home and a second at work, it makes aggregating the readings from the multiple meter for structured testing difficult. For instance, while physicians typically request that their patients bring in all of the meters they use so the physicians can collect all of the data, it was found that most often patients do not comply with this requirement due to the simple hassle factor of trying to collect all of their meters. In both of these instances, data integrity as well as ensuring all data has been properly collected such that are no “holes” in the data are always a concern.

As will be explained below, the technique and system developed by the inventor addresses these issues as well as others by utilizing a portable memory card in which the individual's data is stored and identified based on a personal identification number or key. With this system, the meter and the health care provider are able to track testing data across multiple meters as well as between various individuals. Moreover, it gives the capability of using retrospective analysis in which, while a structured test may have been intended but the specific questions or data input were not available at the time, the individual is allowed to update the data later on when it becomes available. By having the individual's data stored on a memory card or key fob, the individual is able to keep the data in their possession and also helps with patient confidentiality. Moreover, it was found that the use of the memory card/key fob made the system much simpler because, among other things, it avoided the cost and patient privacy concerns associated with meters transmitting information over cellular communication systems.

Another issue that this technique and system addresses is what is termed the “nagging” factor for structured testing. Structured testing is typically intended to be performed for a predetermined period time or short number of days, such as 3 to 7 days. However, the meter typically reminds the user to perform a certain task, such as to eat a meal, conduct a blood glucose test and collect other data. Once the testing period has ended, the meter may continue to alert the user, which can tend to be quite frustrating. These constant and repetitive alerts make compliance difficult in the long term because the individual starts to ignore the reminders. The memory card or key fob helps to eliminate this issue by only performing structured testing when the memory card is inserted and programmed to perform a structured test. Once the memory card is removed or otherwise disassociated from the meter, the meter acts in a normal manner and does not have annoying alarms or alerts that can bother a patient.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a blood glucose monitoring system having an aggregation type configuration.

FIG. 2 is a block diagram of a blood glucose monitoring system having a segregation type configuration.

FIG. 3 is a block diagram of a blood glucose monitoring system having a hybrid aggregation-segregation type configuration.

FIG. 4 is a block diagram of a meter system configured to be used in the systems illustrated in FIGS. 1, 2, and 3.

FIG. 5 is a flow diagram of a technique for performing structured testing in the systems illustrated in FIGS. 1, 2, and 3.

FIG. 6 is a flow diagram of a technique for retrospectively performing structured testing.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity. While the examples below will be described with reference to blood glucose monitoring, it should be appreciated that various aspects of this system and technique can be incorporated to monitor other health issues.

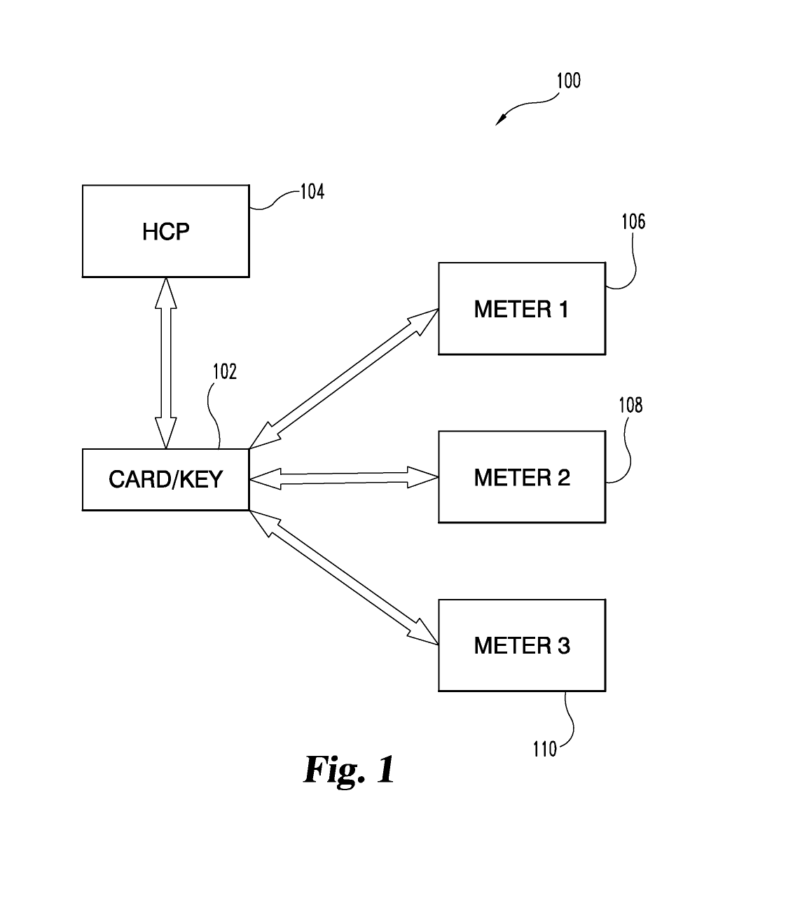

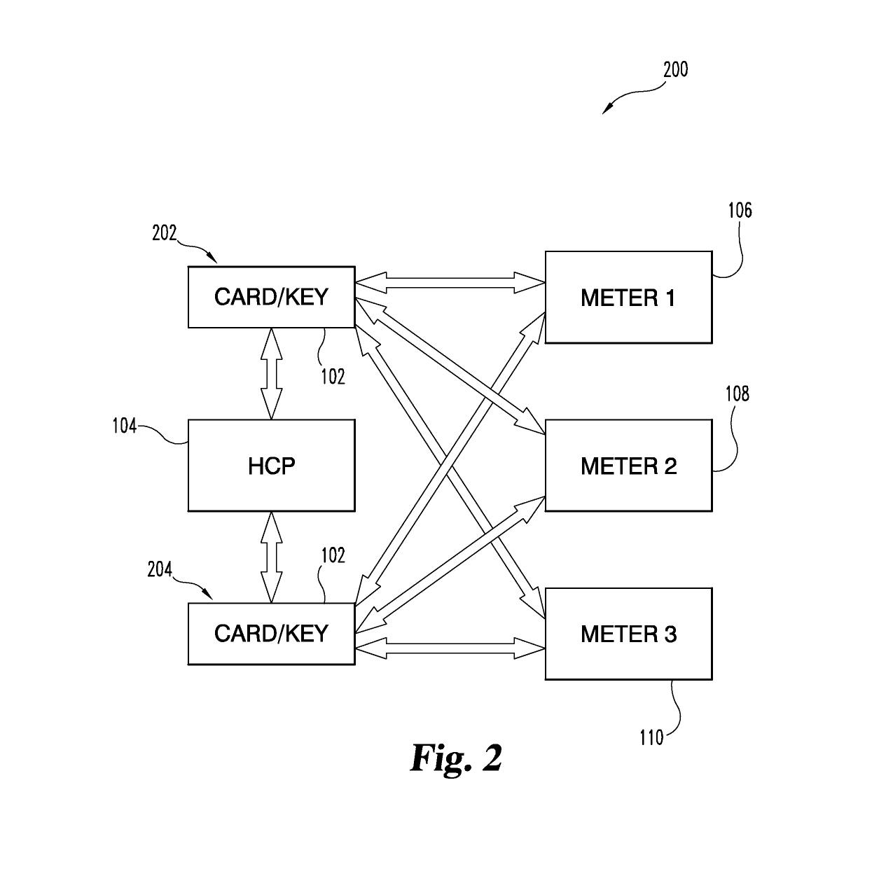

For the convenience of the reader, it should be initially noted that a drawing in which an element is first introduced is typically indicated by the left-most digit(s) in the corresponding reference number. For example, a component identified with a one-hundred series reference number (e.g., 100, 101, 102, 103, etc.) will usually be first discussed with reference to FIG. 1, and a component with a two-hundred series reference number (e.g., 200, 201, 202, 203, etc.) will usually be first discussed with reference to FIG. 2.

As mentioned before, the cost of blood glucose meters in industrialized or developed countries is relatively inexpensive such that a diabetic patient may own more than one. For example, a patient may have a meter they use at home, a meter they use at work, and another that is packed for travel. FIG. 1 shows a diagram of such an example. For the purposes of discussion, it is termed as an example of a health care monitoring system 100 that uses an aggregation-type design for aggregating data from multiple glucose meters. As depicted in FIG. 1, a diabetic patient possesses a portable memory card 102 that includes a personal identification number as well as memory for storing patient data. As used herein, the term “portable memory card” (or some variation thereof) means any type of memory or other information storage media that is designed to be readily inserted and removed from glucose meters or other devices and is designed to retain the information even when removed from the meters. The term “portable memory card” refers to memory that is insertable into the meter post production (i.e., after the meter is manufactured). It should be clearly recognized that the term “portable memory card” does not encompass the memory normally integrated into the glucose meter or other devices, such as core memory. The portable memory card 102 can be in the form of a SIM-type card, SD card, memory stick, and other formats commonly used as portable data storage. By way of nonlimiting examples, the memory card 102 can include wholly or in part solid state electronic random access memory (RAM), sequential access memory (SAM), such as first-in, first-out (FIFO) variety or last-in, first-out (LIFO) variety, programmable read only memory (PROM), electronically programmable read only memory (EPROM), and/or electronically erasable programmable read only memory (EEPROM). In one particular example, the portable memory card 102 is in the form of a key fob that the patient attaches to his or her key chain, but the memory card 102 can come in other forms. In another example, the memory card 102 is in the form of a microchip implant that uses near field communication technology and/or radio frequency identification (RFID) technology to communicate with the meter. Implanting the chip in the patient ensures that it is always with the patient.

A health care provider (HCP) computer 104 is used to not only program the portable memory card 102 but also to receive data from the portable memory card 102. An example of the health care provider computer 104 can include a personal computer, laptop, tablet, cell phone, and/or other type of computing device to name just a few examples. In the illustrated example, the individual uses the portable memory card 102 in conjunction with three meters: a first blood glucose (BG) meter 106, a second BG meter 108, and a third BG meter 110. As noted before, the user may have, for example, the first meter 106 for use at work, the second meter 108 for use at home, and the third meter 110 for use at a vacation home or for travel. The meters can include various types and/or brands of glucose meters, such as continuous glucose monitoring device and/or discrete testing type meters. In a typical testing regimen, the physician asks the individual to bring in all meters so that information may be downloaded from the individual meters, but as a practical matter, this never occurs due to the number of meters involved. With the portable memory card 102, the user is able to aggregate readings from each of the meters to provide to the health care provider. By having the portable memory card 102 in the individual's possession, such as on their key chain, the meter can be personalized for the patient. The portable memory card 102 has a personal identification number or other designation that identifies the individual to the meter, such that when inserted, the meter can be configured specifically for that user. For example, the age, weight, and units of measure (e.g., mmol/l or mg/dl) can be specified for the particular user. In addition, the portable memory card 102 has the ability to store the user's information so the data collected on the various meters 106, 108, 110 can all reside in the portable memory card 102 and data can be aggregated for use by the health care provider computer 104. In other examples, the personal identification number (or other identifier) is not necessarily patient specific, but it is instead used for authorizing specific features, tests, and/or other functionality for glucose meters.

In one particular example, the physician or other health care provider, using the health care provider computer 104, programs a specific structured test that needs to be conducted, and the structured test is downloaded onto the portable memory card 102. In another example, the meters 106, 108 can be used to program the card as well. It should be recognized that the HCP computer 104 and/or the meters 106, 108 can be used to initialize the portable memory card 102 (e.g., link the portable memory card 102 to a particular user), but only the HCP (through any conduit) should configure a tailored function. When the individual inserts the portable memory card 102 into a particular meter, such as the first meter 106, the meter identifies the user and is aware that a structured test needs to be conducted based on information stored on the memory card 102. The first meter 106 in this example then provides the appropriate alerts and collects the data using the portable memory card 102. To avoid any of the nagging factors by providing alerts when they are not needed, once the portable memory card 102 is removed from the first meter 106, the first meter 106 returns to its normal operation mode in which it simply provides blood glucose readings without any structured testing alerts. Returning to the previous example, when the user travels to work and does the blood glucose measurements using the second meter 108, the individual simply inserts the portable memory card 102 into the second meter 108 which then operates to continue the structured testing procedure. Once the portable memory card 102 is removed from the second meter 108, the second meter 108 returns to its normal operational mode in which no alerts are provided for structured testing. The individual can then loan the second meter 108 to another so that they can check their blood glucose levels without affecting the structured test. When the same individual is on a business trip, they can continue the structured test on the third meter 110, which is kept in their travel case, by inserting the portable memory card 102 into the third meter 110. Upon returning from the trip, the individual only needs to take the portable memory card with them to the health care provider's office. At the office, the physician downloads the structured testing results onto the health care provider computer 104 for analysis. With this particular ability of the portable memory card 102, structured testing can be conducted across multiple meters without any data loss. Moreover, the user is not annoyed by having the constant reminders programmed into the glucose meter when structured testing is not required.

As noted before, in developing countries individuals may need to share the same or a group of the same glucose meters or other health monitoring devices. For example, an individual health clinic may only have one glucose meter that is shared among its patients. As should be appreciated, this can create all types of issues for using a structured testing approach because the individual meter is not associated with a particular individual. As a result, structured testing can be extremely difficult due to the difficulty in tracking the various structured tests that need to be performed as well as the ability to associate data with an individual. In addition, performing structured tests is difficult when sharing meters because one individual may not require the structured test alerts that would be used for other individuals also using the meter, but the alerts would still occur on the meter regardless of who was using the meter. Previous health monitoring system designs rely on the internet to transmit patient data. However, it should be recognized that not everyone, especially the elderly, has internet access. This is especially true for those in developing countries. It should be appreciated that the health care monitoring systems described herein do not rely on the internet. This in turn promotes adoption by those without internet access.

A health care monitoring system 200 illustrated in FIG. 2 addresses this issue by the use of the portable memory cards 102. As depicted, a first user or individual 202 has their own key fob or portable memory card 102, and similarly a second individual 204 has their own portable memory card 102. The portable memory cards are relatively inexpensive as compared to a meter, and the individuals 202 and 204 hold onto their individual portable memory cards that contain their personal identification as well as other data collected by the meter. As depicted, the first individual 202 and the second individual 204 share three common meters, but it is contemplated in other embodiments they may share one meter, two meters, or even more than is illustrated. With this ability, the structured tests can be performed using multiple meters that are used by multiple users. If cost is a concern, the health care provider can loan the portable memory card 102 to the subject of the test for the duration of the structured test. Afterwards, the individual can return the portable memory card 102 so that it can be used by others. By doing so, health care related costs can be reduced. The health care provider can also maintain a library of portable memory cards 102 that are programmed to perform different structured tests so as to identify different conditions.

As one example, the health care provider may prescribe a structured test for the first user 202. The first user 202 can insert their portable memory card 102 into the first meter 106, which in turn would then configure the first meter 106 for a structured test having the alerts and other data input requirements as usually occurs for structured testing. In this example, the second user 204 may not require a structured test at this time and may still want to use the first meter 106 when it is not being used by the first user 202. When the second user 204 utilizes the first meter 106, the meter is then configured to not have the alerts normally associated with structured testing, and the second user 204 can perform normal glucose testing as would usually occur. It should be appreciated that this eliminates unnecessary alerts and issues associated with structured testing which in turn is beneficial to both the first 202 and second 204 users. Continuing with this example, if the first meter 106 is not available, the second user can use their portable memory card 102 and insert it into the second meter 108 such that they are able to continue their structured test without any data loss. Once the structured test is complete and/or the first user 202 visits the health care provider, the health care provider via the health care provider computer 104 can download the structured testing data from the portable memory card 102 of the first user 202 and perform the appropriate analysis.

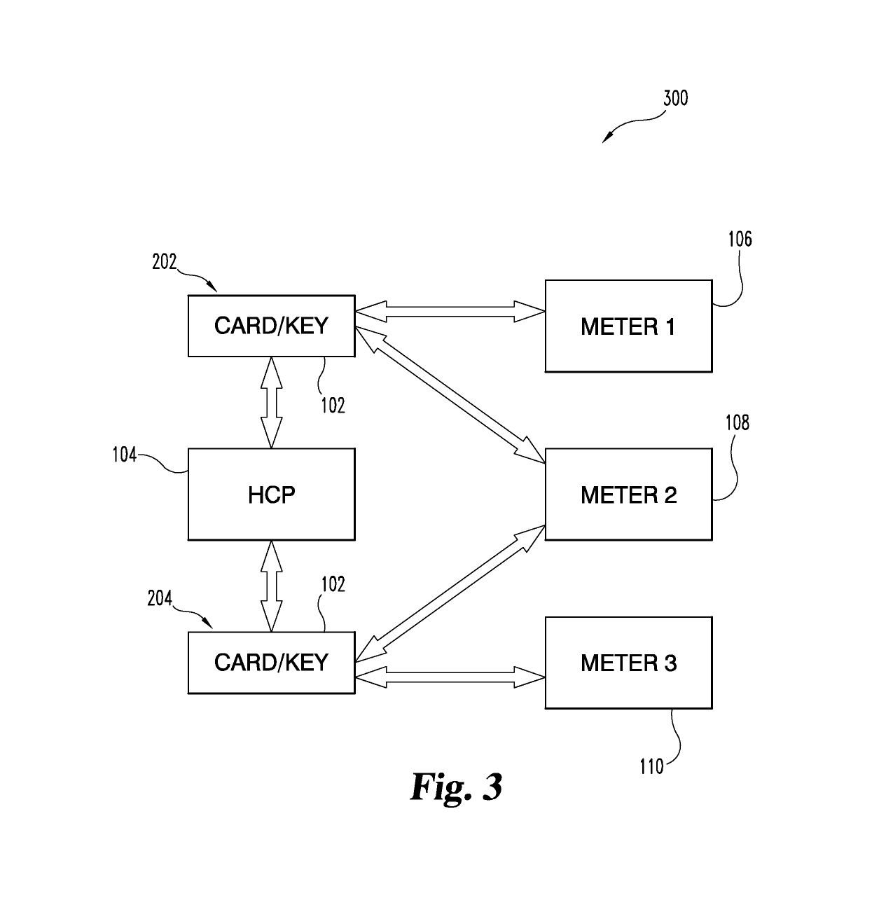

FIG. 3 illustrates a health care monitoring system 300 that utilizes a hybrid approach. That is, it incorporates both aggregation-type and segregation-type systems. As can be seen in this particular example, the first and second users 202, 204 each share a common meter, which in this example is the second meter 108, but at the same time have other meters that they use exclusively. For example, the first user 202 utilizes the first meter 106 exclusively and the second user 204 utilizes the third meter 110 exclusively. This hybrid usage may for example occur when the individual user may have their own personal meter at home but share a common meter when they visit a clinic, doctor, or other type of health care provider. By using the portable memory card 102, the first user 202 and second user 204 can aggregate as well as segregate information from the different meters. This also allows structured testing to be used on an as-needed basis. For example, the first user 202 may be prescribed to perform a structured test whereas the second user 204 may not need to perform such a test (or a different structured test). When they share the common second meter 108, the first user 202, upon inserting the portable memory card 102, can configure the meter to perform the structured tests, but once the memory card 102 is removed and the second user 204 utilizes the second meter 108, the second user 204 would then perform a standard glucose test. With this configuration, the health care provider is then provided the entire history of data collected for both structured testing as well as regular glucose monitoring without the need of having the physical meters in the health care provider's possession. It is contemplated that other system configurations are possible, besides the ones shown in the drawings.

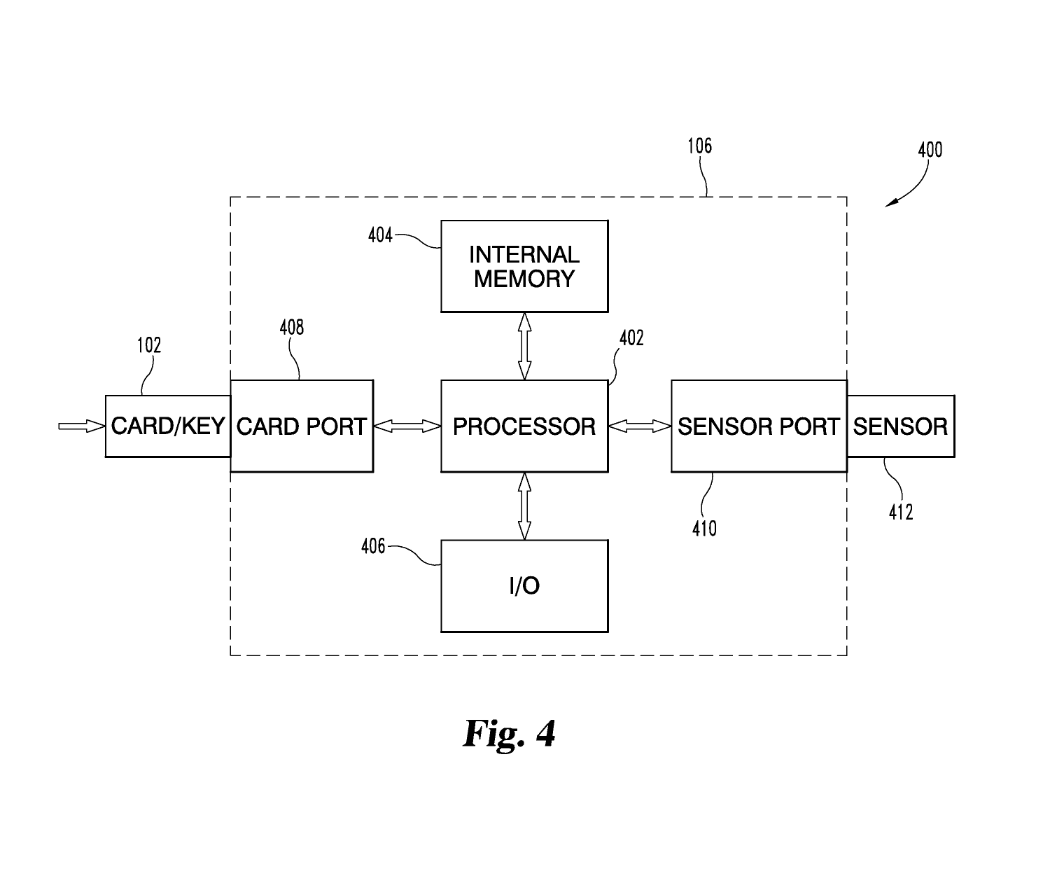

FIG. 4 illustrates a block diagram of a meter system 400 in which the portable memory card 102 is coupled to the first meter 106. As should be appreciated, the first meter 106 can be configured in other manners than as illustrated. For example, the meter system 400 can include a continuous monitoring type meter and/or a non-invasive type meter. In addition, the other meters illustrated in FIGS. 1-3 can be configured the same or differently, depending on the circumstances. As illustrated, the first meter 106 includes a processor 402 for processing data, internal memory 404 for storing data, an input/output (I/O) device 406 and a card port 408 to which the portable memory card 102 is coupled, and a sensor port 410 to which a disposable sensor 412, such as a test strip, is attached. The processor 402 can, for example, include a microprocessor and/or other electronics that are configured to process biosensor data. The internal memory 404 can include random access memory (RAM), read only memory (ROM), some combination of both, and/or other types of memory as would occur to those skilled in the art. The I/O device 406 can include one or more devices such as buttons, displays, touch screens, as well as other types of devices either singularly or collectively for inputting and outputting data. In one particular example, the I/O device 406 includes a touch screen with which the user interacts to enter blood glucose data as well as other information. The card port 408 provides a way of creating an electronic connection between the portable memory card 102 and the meter 106. It is contemplated that the card port 408, in one example, can include electrical contacts that create an electrical connection between the portable memory card 102 and the processor 402. In another example, the card port 408 can include a near field communication wireless type of communication device, such as a BLUETOOTH™ type transceiver, that would communicate with the portable memory card via a BLUETOOTH™ type connection or through an optical type connection, such as through an infrared transceiver. Thus, the portable memory card 102 can be directly coupled to or indirectly associated with the meter to transfer data to and from the first meter 106.

The sensor port 410 allows a disposable biosensor 412 to be coupled to the meter 106. For example, when the meter 106 is a blood glucose meter, the sensor port 410 provides an electrical connection between the meter 106 and the biosensor 412. In one example, the biosensor 412 is a disposable test strip, but it is contemplated that in other variations all or part of the biosensor 412 can be integrated into the meter 106 so as to not be disposable. It should be recognized that the illustrated example is merely a simplified diagrammatic view of the meter system 400, and it is contemplated that the system 400 can include other components normally found in meters. Moreover, the communication paths illustrated by the arrows can be configured differently in other embodiments. Although components such as the processor 402 and internal memory 404 are illustrated as distinct components, it should be appreciated that one or more of the components in the meter system 400 can be integrated together to form a single unit. Likewise, the individual components can be divided into various subcomponents to form and be made of multiple units. For example, the internal memory 404 may include multiple internal memory units.

The processor 402 along with the internal memory 404 and other components of the meter system 400 are designed to perform the techniques described herein. In the following description of the flow charts, it should be recognized that the methods or techniques are performed using the processor 402, internal memory 404, I/O device 406, card port 408, and sensor port 410 as well as other components of the meter system 400. These techniques can be programmed as software, firmware, and/or hard coded in the hardware of the meter system 400.

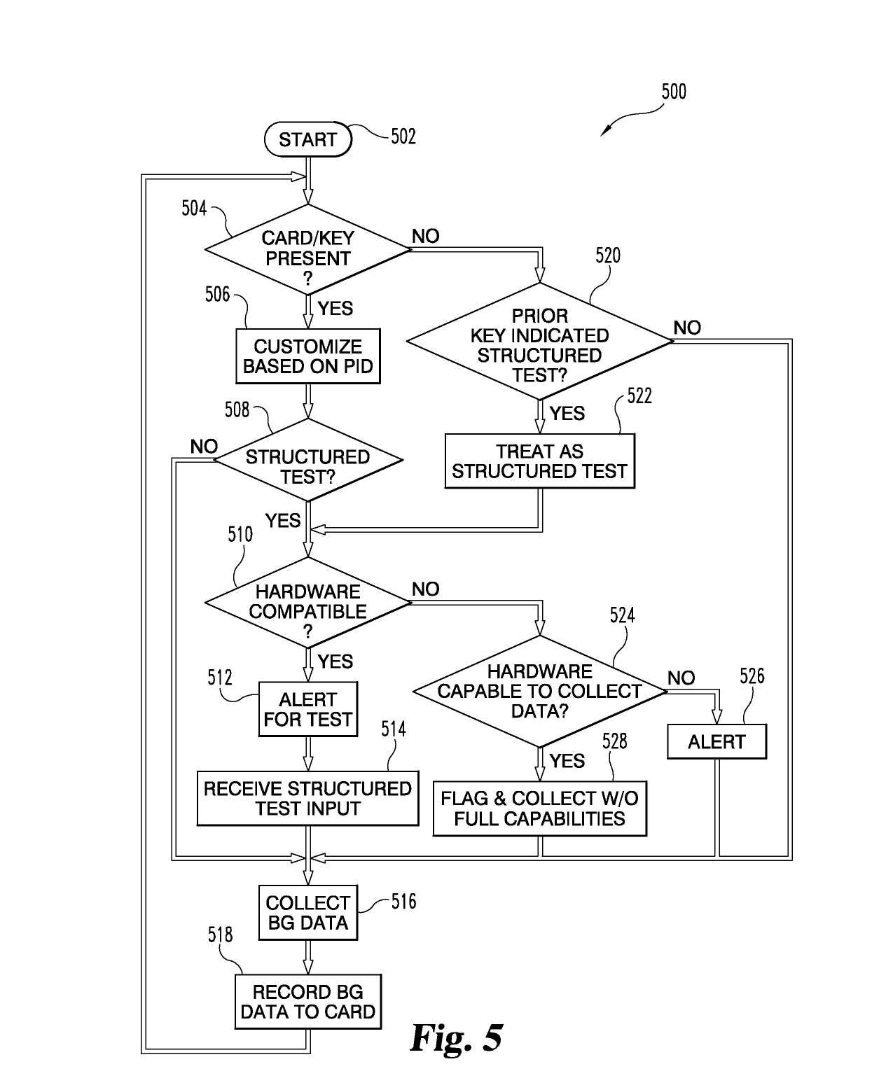

A technique for performing a structured test using for example the aggregation-type monitoring system 100 (e.g., FIG. 1), the segregation-type monitoring system 200 (e.g., FIG. 2), the hybrid system 300 (e.g., FIG. 3) or some other variation will now be described with reference to flow chart 500 in FIG. 5. Generally speaking, flow chart 500 shows the overall logic that the processor 402 of the meter 106 takes during processing of the structured test and interfacing with the portable memory card 102. After an initialization stage 502, the processor 402 of the meter 106 determines whether the portable memory card 102 is coupled to or otherwise associated with the card port 408 of the meter 106 in stage 504. The meter 106 can determine the presence of the portable memory card 102 in any number of manners. For instance, a simple closed contact for one of the electrical contacts in the card port 408 can be used to signify that the portable memory card 102 is inserted.

As noted before, each portable memory card 102 has a unique personal identification (PID) number that identifies the individual patient. The portable memory card 102 can also include additional information for customizing the meter 106 based on data contained within the portable memory card 102. In stage 506, based on the PID number and/or other information such as specific flags, the meter 106 can be configured and customized to fit the personal needs of the individual (e.g., units of measure). For instance, the units measured as well as alerts and alarms can be updated for a specific user. In another example, simply based on the PID number the processor 402 retrieves from internal memory 404 the specific customized configuration stored in the internal memory of the meter 106. It should be recognized that the meter 106 can be customized or programmed in other manners.

The health care provider via the health card provider computer 104 can program the portable memory card 102 for a specific structured testing regimen. For example, a physician may want the diabetic patient over a number of days to measure blood glucose levels before eating each meal and two hours after each meal as well as to record the size of the meal to determine whether a change in insulin dosage or some other change needs to occur. The health care provider computer 104 can be used to program the portable memory card 102 to indicate whether a structured testing regimen needs to occur, and if so, what type. The specific details of the structured testing regimen can reside on the portable memory card 102, can be stored within the internal memory 404 of the meter 106, can be remotely located on some other device, and/or can include some combination of these storage configurations. For example, the portable memory card 102 can include data for programming the meter 106 to perform all of the alerts and data collection requirements for a specific structured testing regimen. In another example, the portable memory card 102 may include an identification number that activates a specific structured testing regimen pre-programmed in the internal memory 404 of the meter 106. In still yet another alternative, the portable memory card 102 may include a path or universal resource locator (URL) that triggers the processor 402 to download a specific testing regimen from the internet. It should be appreciated that a combination of all of these techniques or other techniques may be used to program the meter 106 for a structured testing regimen.

In stage 508, the processor 402 of the meter 106 determines whether a structured test is warranted. For instance, based on the PID number stored on the portable memory card 102, the processor 402 can determine based on information stored in the internal memory 404 whether the individual matching the PID number is required to perform structured testing. In another example, the portable memory card 102 can contain a flag as well as other information indicating that structured testing is required. If the portable memory card 102 indicates that no structured testing is required, then the meter 106 operates in a normal fashion and collects traditional blood glucose data. On the other hand, if the meter 106 determines in stage 508 that structured testing is required, the processor 402 of the meter 106 determines whether or not the particular meter is compatible with the required structured testing regimen. Alternatively or additionally, the portable memory card 102 can make such a determination as to compatibility and alert the processor 402 of any incompatibility issues. The meter 106 may be incompatible for a particular structured test or even all structured testing for a whole host of reasons. For example, the meter 106 may not have enough precision for a specific structured test and/or may not have the proper I/O device 406 for entering data into the meter 106. In other examples, the internal memory 404 of the meter 106 may not be large enough and/or configured properly to record additional data required for the structured test. The meter 106 may also be needed to collect data but be limited in functionality for a structured test. For example, a structured test may require a graphical display to provide custom prompts (e.g., “have you been fasting for the last 8 hours?”). However, if the meter 106 only has an icon-based display, the structured test can still be performed by collecting data (e.g., blood glucose readings) at the appropriate times. When the portable memory card 102 is later placed in a device that has a graphical display, the device can prompt the user to enter the appropriate additional information. The structured test for instance may require the user to enter information about meals consumed, exercise activities, medication information, energy levels, and other possible factors for diabetic control problems which some generic, low featured meters are unable to store and/or process.

On the other hand, if the meter 106 is compatible with the structured test, the processor 402 of the meter 106 creates any required alerts for the structured test in stage 512 and, if needed, programs or structures the internal memory 404 so as to be able to store the additional data. For example, if the I/O device 406 includes a speaker, the meter 106 can be programmed to generate an alarm for the user to perform a particular test, and a portion of the internal memory 404 can be assigned to store the additional data. In a similar fashion, when the I/O device 406 includes a display, the display may also alert the user to perform a test and/or provide additional instructions about the test. Returning to the previous example in which the testing occurs in a window around each meal, the I/O device 406 in stage 512 instructs the user to take a blood glucose reading before the meal as well as characterize the size and type of meal. Alternatively or additionally, the alert in stage 512 may also inform the user that the meter 106 is compatible with the prescribed structured test.

In stage 514, the user enters into the meter 106 one or more pieces of data related to the structured test, and the meter 106 receives this data input that is used to provide context to the blood glucose readings. As should be appreciated, structured testing analysis is not based purely on blood glucose levels; rather, other contextual data is collected along side the blood glucose readings such that the contextual data is able to identify one or more sources for the blood glucose control problem. This contextual data can for example include information about exercise habits, mental state, sleep habits, diet (e.g., meal size, nutritional content, carbohydrates, calories, time of day, etc.), general activity levels, medication (e.g., insulin dosages) as well as other information that may directly or indirectly affect glucose control. By identifying a potential source for the problem through the structured test, the physician or other health care provider can prescribe a treatment therapy to combat the identified glucose control problem. It should be recognized that different treatment therapies might be required depending on the relationships between the contextual data. As a case in point, a diabetic with a fasting blood glucose that is too high and a post lunch blood glucose level that is too low may require a different treatment therapy from a diabetic who has a fasting blood glucose that is too high as well as a post lunch blood glucose level that is too high. It should be recognized that this structured testing data in stage 514 can be collected at other times than is shown in FIG. 5. For instance, insulin dosage data can be collected after a blood glucose reading is entered in stage 516. The collected information in stage 514 can be temporarily stored in the internal memory 404 of the meter 106 and/or immediately written to the portable memory card 102.

In stage 516, the meter 106 can collect the blood glucose data related to the structured test, or alternatively if no structured test is required, simply collect the traditional blood glucose readings. As should be appreciated, the blood glucose data can be collected by the user applying a blood sample to the test strip 412 which is in turn drawn and analyzed electrochemically, photometrically, and/or in other manners as would occur to those skilled in the art. It should also be recognized that blood glucose readings can be collected at other times than is shown in FIG. 5. For instance, the blood glucose readings can be collected before the other structured testing data is even collected in stage 514. In stage 518, the blood glucose readings and/or other data, for example from stages 514 and 516, can be recorded to the portable memory card 102. The recording of data to the portable memory card 102 can occur at other times as well. For example, the data collected in stage 514 can be immediately written to the portable memory card 102. Alternatively or additionally, the data may also be stored in the internal memory 404 to act as a backup for the portable memory card 102 or as a standalone option. Recording the data to the portable memory card 102 right after the data is received ensures the data is always present on the portable memory card 102. However, in other variations, multiple blood glucose readings and/or other structured data can be downloaded at one time in a batch type fashion. In still yet another example, when the portable memory card 102 is inserted into the meter 106, the information from the portable memory card 102 is reconciled with the information in the internal memory 404 so that all of the data can be shared and aggregated in one place. When reconciling the data, all of the data can then be stored on the portable memory card 102 and/or in the internal memory 404 of the meter 106. With this reconciliation or sharing technique, almost all of the data will be readily available on any of the meters that interface with the portable memory card 102. This can be helpful in cases when the patient forgets to bring the portable memory card 102 to the physician's office but the patient has the meter 106, because the physician can still download most, if not all, of the data from the meter 106. It should be appreciated that precautions can be taken with this technique, such as encrypting the data, so as to prevent unauthorized access to the data. For instance, only the data pertaining to a specific patient identification number identified on the portable memory card 102 and/or on the meter 106 are exchanged between the two.

As is shown by the flow chart 500 in FIG. 5, once the data is recorded in stage 516, the processor 402 then determines whether the memory card 102 is still present or otherwise in communication with the meter 106 in stage 504. If so desired, the meter 106 via the I/O device 406 in stage 504 can also alert the user that the portable memory card 102 has been removed or not properly seated. This addresses the issue of the user removing the portable memory card 102 either unintentionally or accidentally.

As discussed before, the portable memory card 102 also addresses the “nagging” factor in which the meter 106 alerts the user to perform specific acts of a structured test after the test has been completed (or is not required). Generally speaking, the memory card 102 acts like a key such that the structured test alerts only occur within the specific window for a particular user needing to perform a structured test. When the portable memory card 102 is not present in stage 504, the processor 402 of the meter 106 in stage 520 determines based on information from the previously inserted key whether the prior user was in the midst of a structured test. If not, the meter 106 operates in a normal fashion without any alerts for performing a structured test. That is, the meter 106 proceeds to stage 516 in FIG. 5 so as to collect blood glucose readings under normal operational conditions. By reducing the nagging factor created by unnecessary structured testing alerts, the individual user is more likely to follow the alerts and/or instructions when a structured test is actually required. In addition, this technique helps to facilitate sharing of meters between multiple users in which some are required to perform a structured test and others are not (or need to perform different structured tests).

Another feature of this technique is the ability to infer when structured testing needs to be performed even if the portable memory card 102 is not in communication with or otherwise secured to the meter 106. When the processor 402 of the meter 106 determines that no portable memory card 102 is attached to the card port 408 and the current time is still within the window of the structured test, the processor 402 assumes that the previous structured test was interrupted and should still be occurring. For example, a user is instructed to perform a three day structured test and only one day of data collection has occurred before removal of the portable memory card 102, the processor 402 can, if desired, infer that the structured test should still be occurring. To ensure the same individual is using the meter 106, the meter 106 for instance may request via the I/O device 406 the user to identify themselves. Based on information stored in the internal memory 404, the processor 402 in stage 520 determines whether the particular individual is required to still perform a structured test based on information downloaded from the portable memory card 102 when previously inserted in the meter 106. For example, when the internal memory 404 has a flag indicating structured testing is still required, the processor 402 of the meter 106 in stage 522 operates as if the structured testing is required and performs a typical structured test. The structured testing flag in internal memory 404 can have an expiration time such that after the expiration period, the flag is changed to indicate that structured testing is no longer required. Alternatively or additionally, the meter 106 via the I/O device 406 may request that the user confirm that a structured test is required. If the information contained in the internal memory 404 and/or elsewhere indicates that a structured test should not be inferred, the meter 106 performs normal blood glucose data collection in stage 516.

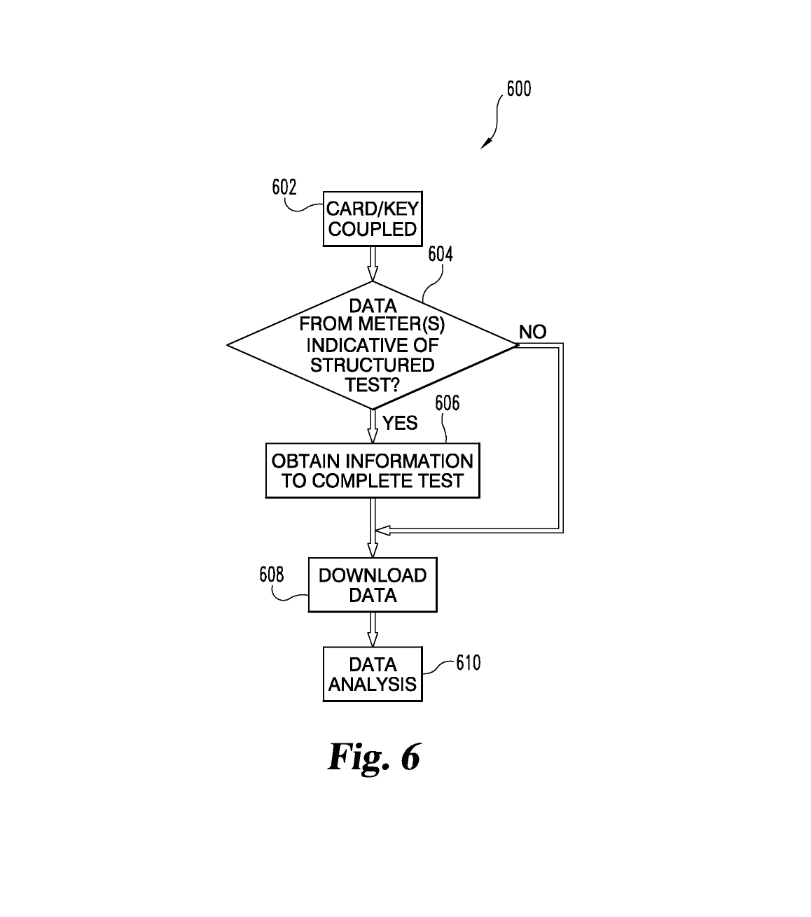

As noted above, the meter 106 in stage 510 determines whether the meter 106 is capable of performing a structured test. For example, the I/O device 406 may not have the capability for entering and/or displaying the information required for the particular structured test. If the meter hardware and/or software is not compatible with the particular structured test for the user or structured testing in general, the processor 402 of the meter 106 then determines in stage 524 whether the hardware and/or software is capable of providing and/or collecting at least some of the information required for structured testing. In an alternative embodiment, the determination in stage 524 can be performed by the portable memory card 102 and/or some other external device. If the meter 106 is incapable of even partially performing the structured test, such as for example the meter 106 does not have the required precision, the meter 106 then alerts the user in stage 526 that the meter 106 is incapable of performing any structured testing via the I/O device 406. The meter 106 proceeds to stage 516 so as to collect blood glucose readings in its normal operational mode. On the other hand, if the meter 106 is capable of performing at least some of the functions required of structured testing, the processor 402 of the meter 106 flags the data and proceeds with the blood glucose measurement collection without the full capabilities in stage 528. In stage 528, the meter 106 can also alert the user that the meter is only able to partially perform the structured test. If appropriate, the meter 106 in stage 528 also can instruct the user to record the required structured testing data in a paper logbook (or in some other manner). To illustrate this point, the meter 106 can for example instruct the user via the I/O device 406 to record meal size, type, and time information along with insulin dosages and blood glucose readings in a patient logbook when the meter 106 is not able to record the information. This technique allows at least part of the structured testing procedure to be performed. If needed, some retrospective input of data required for structured testing may occur using the technique such as will be described with reference to FIG. 6.

FIG. 6 shows a flow chart 600 that illustrates a technique for retrospectively performing structured testing. That is, the ability to reconstruct a structured test when the blood glucose readings were measured or other information was entered in the required time periods but where other information, such as meal size, activity level, and other information required for structured testing, was unable to be collected at the time. This provides the ability to fill in the blanks and to avoid losing valuable structured testing information. This retrospective technique can be performed using a meter capable of doing the full functions of structured testing, on the patient's personal computer, on a health care provider computer 104, or using other types of devices capable of performing the required function for this retrospective technique. For the purposes of explaining the technique, it will be described with respect to entering the retrospective information via the user's home computer, but again it is envisioned that other devices, such as the glucose meter 106, can be used to perform this retrospective structured testing. In stage 602, the memory card 102 is coupled or otherwise establishes communication with the computer such as via a card reader (e.g., card port 408 in FIG. 4). In stage 604, the computer determines whether the data on the portable memory card 102 gives an indication that the user was attempting to perform a structured test. For example, the computer can determine whether the blood glucose data on the portable memory card 102 was collected within the time frame required for structured testing which would then indicate the user was attempting to perform the structured test. On the other hand, if the data from the portable memory card 102 in stage 604 does not provide a clear indication that it was collected as part of a structured test, the computer does not attempt to retrospectively reconstruct the structured test. Instead, any data from the portable memory card 102 is just downloaded and processed in stage 608 without any attempt to reconstruct the structured test. This can happen for example when the date-time stamps for the data on the portable memory card 102 do not match the timing for the structured test.

When there is an indication in stage 604 that a structured test was attempted and/or the information required to at least partially fill in the structured testing data is available on the portable memory card 102, the computer obtains other information to complete the structured test in stage 606. For instance, the computer can display and request answers to a series of questions relating to the structured test, such as what meals they ate during the test, activities/exercises performed, medication dosages, blood glucose readings, and the like. The information entered in stage 606 can be based on the user's memory or on information contemporaneously record at the time, such as in the logbook that was discussed previously. When the information is entered based on memory alone, the computer can be configured to ask variations of the same question or take other precautions to ensure that the user's memory is accurate about events that took place during the structured test. With the now complete data set for structured testing, the data in stage 608 can be downloaded either to the portable memory card 102 and/or directly into the health care provider computer 104. It should be recognized that the data can be downloaded to other systems as well. In stage 610, any data is analyzed using normal structured testing analysis. Utilizing this retrospective structured testing technique helps improve compliance which in turn helps to avoid frustration of the user because data that was normally collected by a structured test is not lost.

As should be appreciated, the techniques described above allow the meter system 400 to perform structured testing in both segregation-type and aggregation-type collection environments. By having the data collected on the portable memory card 102, information from multiple meters is able to be aggregated, such as in an aggregation example illustrated in FIG. 1, so there is one source from which the health care provider can collect all of the structured testing data required for analysis. The above-described techniques also allow multiple users to perform different structured tests (or no structured test) on the same meter, such as in the segregation example illustrated in FIG. 2, or via some hybrid approach, such as illustrated in FIG. 3. As discussed before, these techniques and systems also avoid the nagging factor which, among other things, can reduce structured testing compliance. The portable memory card 102 in essence acts like a key by only having the structured test alerts occur on an as-needed basis. Again, when the portable memory card 102 is not present, the meter 106 operates in a normal fashion. It nevertheless should be appreciated that this key-like aspect of the portable memory card 102 is not mandatory in every instance. For example, there are other use cases in which further features of the portable memory card 102, such as its ability to aggregate or segregate data, can be used without this key-like feature. In addition, this technique helps to avoid structured testing being performed on meters that are incapable of performing structured tests as well as facilitates partial structured tests to be performed when the meter is only partially capable of performing a structured test. This technique further allows structured tests to be performed even if the user accidentally forgets to insert the portable memory card 102 into the meter 106 such that the meter 106 is able to infer structured testing is needed. Furthermore, this technique facilitates the ability to do retrospective structured testing. That is, the ability to perform structured tests even though some or most of the data was not contemporaneously entered when the blood glucose readings were made or at the appropriate time.

It should be recognized that numerous other variations to the systems and methods described above are possible. Depending on the desired functionality, various stages of the above-described techniques can be eliminated, duplicated, and/or reordered, depending on the requirements. For example, the data input occurring in stages 514 and 516 can occur in a different order than is shown in FIG. 5.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method, comprising:
detecting a portable memory card with a glucose meter; and
configuring a function for the glucose meter in response to said detecting the portable memory card.

2. The method according to claim 1, wherein said configuring includes enabling the function for the glucose meter.

3. The method according to claim 1, wherein said configuring includes performing the function.

4. The method according to any previous claim 1, wherein the function includes a structured test.

5. The method according to claim 4, wherein the structured test includes at least one glucose reading from a user and at least one other piece of data about the user that provides context to the glucose reading.

6. The method according to claim 5, further comprising:
measuring the glucose reading with the glucose meter after said configuring;
requesting the other piece of data with the glucose meter; and
recording the other piece of data from the user with the glucose meter.

7. The method according to claim 5, or wherein the other piece of data includes dietary information.

8. The method according to claim 4, further comprising:
storing results of the structured test on the portable memory card.

9. The method according to claim 8, further comprising:
wherein said storing the results of the structured test on the portable memory card includes aggregating the results of the structured test across multiple glucose meters; and
downloading the results of the structured test from the portable memory card onto a health care provider computer.

10. The method according to claim 9, wherein said downloading includes downloading the results directly onto the health care provider computer via a card reader.

11. The method according to claim 9, wherein said downloading includes downloading the results indirectly onto the health care provider computer via at least one of the glucose meters.

12. The method according to claim 8, further comprising:
measuring blood glucose readings for different users with the same glucose meter; and
wherein said storing the results of the structured test on the portable memory card includes segregating the results of the structured test based by user in the portable memory card.

13. The method according to claim 12, wherein said segregating the results includes indentifying the user in the portable memory card by a personal identification number.

14. The method according to claim 4, further comprising storing configuration, schedules, data, and status of all structured tests on the portable memory card.

15. The method according to claim 1, wherein said configuring includes disabling the function for the glucose meter.

16. The method according to claim 1, further comprising:
recording configuration information from a second glucose meter on the portable memory card before said configuring; and
wherein said configuring includes programming the glucose meter with the configuration information from the second glucose meter.

17. The method according to claim 16, further comprising:
loading the portable memory card into the second glucose meter before said recording; and
removing the portable memory card from the second glucose meter after said recording.

18. The method according to claim 16, wherein the configuration information includes units of measure and time zone information.

19. The method according to claim 1, wherein said detecting the portable memory card includes sensing insertion of the portable memory card into the glucose meter.

20. The method according to claim 1, further comprising returning the glucose meter to a standard operational mode upon sensing the portable memory card being disassociated from the glucose meter.

21. The method according to claim 1, wherein said detecting the portable memory card includes reading data on the portable memory card that signifies that the structured test needs to be performed.

22. The method according to claim 4, further comprising:
storing a structured testing time window in the glucose meter
sensing the portable memory card being disassociated from the glucose meter;
determining with the glucose meter that current time is still within the structured testing time window with the glucose meter after said sensing the portable memory card being disassociated from the glucose meter; and
conducting the structured test with the glucose meter after said determining the current time is still within the structured testing time window.

23. The method according to claim 1, further comprising:
limiting alarms by the glucose meter to only when the portable memory card is associated with the glucose meter.

24. The method according to claim 4, wherein said configuring the glucose meter includes:
determining the glucose meter lacks capabilities to perform at least part of the structured test; and
alerting the user with the glucose meter in response to said determining.

25. The method according to claim 24, further comprising collecting with the glucose meter data from the structured test that the glucose meter is capable of collecting.

26. The method according to claim 4, further comprising retrospectively collecting from the user at least part of the data from the structured test after when the structured test was performed.

27. The method according to claim 26, wherein said retrospectively collecting includes collecting part of the data from the structured test with a personal computer.

28. A method, comprising:
measuring a blood glucose reading with a glucose meter; and
storing the blood glucose reading on a portable memory card.

29. The method of claim 28, wherein the portable memory card includes any type of memory or other information storage media that is designed to be readily inserted and removed from the glucose meter, wherein the portable memory card is designed to retain the glucose reading even when removed from the meter.

30. The method according to claim 28, further comprising downloading the glucose reading from the portable memory card onto a health care provider computer.

31. The method according to claim 28, wherein said storing includes storing on the portable memory card information associated with a function for the glucose meter.

32. The method according to claim 31, wherein the information includes structured testing information.

33. The method according to claim 31, wherein the information includes configuration information for the glucose meter.

34. The method according to claim 28, further comprising:
inserting the portable memory card into a second glucose meter; and
downloading data from the second glucose meter onto the portable memory card.

35. The method according to claim 28, further comprising reconciling data from the second glucose meter with data on the portable memory card so that the data on both the second glucose meter and the portable memory card is the same.

36. The method according to claim 28, wherein the portable memory card includes any type of information storage media that is designed to be readily inserted and removed from the glucose meter, wherein the portable memory card is designed to retain the glucose reading even when removed from the meter.

37. (canceled)

38. A system, comprising:
a portable memory card; and
a glucose meter programmed to perform a structured test upon detecting presence of the portable memory card.

39. The system according to claim 38, wherein the glucose meter is programmed to detect presence of the portable memory card when the portable memory card is inserted in the glucose meter.

40. The system according to claim 38, wherein the portable memory card is configured to aggregate the results of the structured test across multiple glucose meters.

41. The system according to claim 38, wherein the portable memory card is configured to segregate the results of the structured test between users.

42. The system according to claim 38, wherein the glucose meter is programmed to discontinue the structured test upon disassociation of the portable memory card from the glucose meter.

43. The system according to claim 38, wherein the glucose meter is programmed to continue the structured test upon disassociation of the portable memory card from the glucose meter so long as the structured test is within a time window for the structured test.

44. The system according to claim 38, wherein:
the portable memory card identifies the structured test to be performed; and
the glucose meter is configured to determine compatibility of the glucose meter with the structured test.

45. The system according to claim 44, wherein the glucose meter includes an output device configured to alert a user when the glucose meter is incompatible with the structured test.

46. The system according to claim 44, wherein the glucose meter is configured to perform at least part of the structured test when the glucose meter is incompatible.

47. The system according to claim 38, further comprising:
a computer configured to interface with the portable memory card, the computer being programmed to identify whether the structured test was attempted based on information from the portable memory card, the computer being programmed to retrospectively collect data for the structured test that was not collected during the structured test.

48. The system according to claim 38, further comprising:
a health care provider computer programmed to download data for the structured test from the portable memory card for analysis.
